(19) United States
(12) Patent Application Publication
(10) Pub. No.: US 2012/0236556 A1
(43) Pub. Date: Sep. 20, 2012

(54) Surface Light Source Device

(75) Inventors: Masao YAMAGUCHI, Kawaguchi (JP); Shigeru NAGIYAMA, Kawaguchi (JP)

(73) Assignee: ENPLAS CORPORATION, Kawaguchi-shi (JP)

(21) Appl. No.: 13/408,269

(22) Filed: Feb. 29, 2012

(30) Foreign Application Priority Data
Mar. 17, 2011 (JP) 2011-059517

(51) Int. Cl. F21V 5/00

(52) U.S. Cl. 362/235

(57) ABSTRACT

No other light emission center is included on four edges and within an area surrounded by the four edges of a quadrangle of which light emission centers of four predetermined light sources serve as apexes. A light diffusing member having a first surface that opposes the light sources and a second surface 6 on the side opposite to the first surface is disposed. The light diffusing member emits light emitted from each light source from the second surface in a dispersed state. Projections having a predetermined pyramid shape are formed in an array on the second surface. A virtual bottom surface of the projection positioned on the second surface is configured by a plurality of linear bottom edges. All bottom edges have a positional relationship that is twisted in relation to the four edges and diagonal lines of the quadrangle.

### TECHNICAL FIELD

The present invention relates to a surface light source device. In particular, the present invention relates to a direct-light type surface light source device suitable for diffusing light from a plurality of point-like light sources using a light diffusing member.

### BACKGROUND ART

An edge-light type or a direct-light type surface light source device has been used since the past for a backlight of a liquid crystal display device, an internally illuminated signboard, a lighting device, and the like.

Here, the edge-light type surface light source device is known as a surface light source type that uses a light guide panel to extract light from a light source disposed on a side end surface of the light guide panel towards a front surface side (visible side) that is perpendicular to the side end surface. On the other hand, the direct-light type surface light source device is known as a surface light source type in which a plurality of point-like light sources are disposed on a back side (directly underneath) of a light diffusing plate. Light from each light source is diffused by the light diffusing plate and extracted towards a surface side.

Of the two surface light source types, the direct-light type is advantageous in terms of luminance and is particularly often used for image display and light emission over a large area.

Since the past, reduced thickness and lower cost have been demanded of this type of surface light source device. However, when the distance between the point-like light sources and the light diffusing member is shortened in response to the demand for reduced thickness, and when the number of point-like light sources is reduced in response to the demand for lower cost, in both instances, a problem has been identified in that the regions directly above the point-like light sources become conspicuously bright and luminance distribution on an exit surface of the surface light source device becomes uneven.

Therefore, as a technology capable of responding to issues such as that described above, a conventional technology described in Patent Literature 1, for example, has been proposed.

In other words, in Patent Literature 1, to counter contrast caused by light source images occurring two-dimensionally as a result of the point-like light sources being disposed within a plane (paragraph 0005 of Patent Literature 1), or in other words, conspicuous brightness directly above the point-like light sources, a plurality of projections are disposed on the exit-side surface of the light diffusing member (light control member in Patent Literature 1).
Patent Literature 1: Japanese Patent Laid-open Publication No. 2010-44922

### DISCLOSURE OF INVENTION

### Problem to be Solved by the Invention

However, in the technology described in Patent Literature 1, the array direction of the projections on the light diffusing member is aligned (parallel) with the array direction (X-axis direction, Y-axis direction, or a diagonal line direction) of the point-like light sources.

Therefore, the light emitted in a planar shape from the light diffusing member may become that in which sections that become relatively bright as a result of the projections performing light path conversion in an effective direction on the light from the plurality of point-like light sources (particularly light from adjacent point-like light sources) and sections that become relatively dark as a result of the projections performing light path conversion in a direction away from the effective direction on the light from the plurality of point-like light sources are positionally unevenly distributed. Effective functioning of the light path conversions by the projections on the overall exit surface becomes difficult. For example, when the brightness directly above the point-like light sources is suppressed, the positions on the planar light corresponding to intermediate points between point-like light sources adjacent to each other in the diagonal line direction become dark,

Therefore, the technology described in Patent Literature 1 is also insufficient for achieving luminance uniformity.

Therefore, the present invention has been achieved in light of the above-described issues. An object of the present invention is to provide a surface light source device capable of easily improving luminance uniformity through modification of a positional relationship between point-like light sources and a light diffusing member.

### Means for Solving Problem

To achieve the above-described object, a surface light source device according to a first aspect of the present invention is that in which a plurality of point-like light sources of which respective exit directions of light are parallel with one other are disposed on a same plane such as to be spaced apart two-dimensionally. In addition, the light sources are disposed such that, on four edges and within an area surrounded by the four edges of a quadrangle of which the apexes are light emission centers of four predetermined light sources, a light emission center point of a light source other than the four light sources is not included. A light diffusing member having a first surface that opposes the light sources and a second surface on the side opposite of the first face is disposed in a position on the exit direction side in relation to the plurality of light sources such as to be parallel with the plane. In the light diffusing member, light emitted from each light source enters the first surface and exits the second surface in a dispersed state. Projections having a predetermined pyramid shape are formed in an array on the second surface of the light diffusing member. A virtual bottom surface of the projection positioned on the second surface is configured by a plurality of linear bottom edges. All bottom edges are disposed as skew lines in relation to the four edges and the diagonal lines of the quadrangle.

In the invention according to the first aspect, the bottom edges of the projections on the second surface of the light diffusing member are disposed such as to have a positional relationship that is twisted in relation to the four edges and the diagonal lines of the quadrangle hypothesized for the set of four point-like light sources. Therefore, sections where light intensity (light quantity) becomes stronger and sections where light intensity becomes weaker in the outgoing light from the second surface of the light diffusing member can be positionally dispersed. As a result, luminance uniformity can be easily improved with certainty.

In addition, a surface light source device according to a second aspect is the surface light source device according to the first aspect, in which the plurality of light sources are disposed in a square lattice shape such that a square is hypothesized as the quadrangle.

In the invention according to the second aspect, luminance uniformity can be improved with certainty, even in instances in which the point-like light sources are disposed in a square lattice shape.

In addition, a surface light source device according to a third aspect is the surface light source device according to the first aspect, in which the plurality of light sources are disposed in a zig-zag manner such that a parallelogram is hypothesized as the quadrangle.

In the invention according to the third aspect, luminance uniformity can be improved with certainty, even in instances in which the point-like light sources are disposed in a zig-zag manner.

Furthermore, a surface light source device according to a fourth aspect is the surface light source device according to the second aspect, in which the pyramid is a quadrangular pyramid. All bottom edges of the pyramid form an angle of 22.5° in relation to a predetermined edge of the four edges of the square and either of the two diagonal lines of the square in a state in which the bottom edges are projected on the plane.

In the invention according to the fourth aspect, offset angles of the bottom edges of the projection in relation to a predetermined edge and one diagonal line of the square can be distributed in a well-balanced manner. As a result, luminance uniformity can be further improved.

A surface light source device according to a fifth aspect of the present invention is that in which a plurality of point-like light sources of which respective exit directions of light are parallel with one other are disposed on a same plane such as to be spaced apart two-dimensionally. In addition, the light sources are disposed such that, on four edges and within an area surrounded by the four edges of a quadrangle of which the apexes are light emission centers of four predetermined light sources, a light emission center point of a light source other than the four light sources is not included. A light diffusing member having a first surface that opposes the light sources and a second surface on the side opposite of the first face is disposed in a position on the exit direction side in relation to the plurality of light sources such as to be parallel with the plane. In the light diffusing member, light emitted from each light source enters the first surface and exits the second surface in a dispersed state. Recesses having a predetermined pyramid shape are formed in an array on the second surface of the light diffusing member. An opening rim of the recess is configured by a plurality of linear opening edges. All opening edges are disposed as skew line in relation to the four edges and the diagonal lines of the quadrangle.

In the invention according to the fifth aspect, the opening edges of the recesses on the second surface of the light diffusing member are disposed such as to have a positional relationship that is twisted in relation to the four edges and the diagonal lines of the quadrangle hypothesized for the set of four point-like light sources. Therefore, sections where light intensity (light quantity) becomes stronger and sections where light intensity becomes weaker in the outgoing light from the second surface of the light diffusing member can be positionally dispersed. As a result, luminance uniformity can be easily improved with certainty.

In addition, a surface light source device according to a sixth aspect is the surface light source device according to the fifth aspect, in which the plurality of light sources are disposed in a square lattice shape such that a square is hypothesized as the quadrangle.

In the invention according to the sixth aspect, luminance uniformity can be improved with certainty, even in instances in which the point-like light sources are disposed in a square lattice shape.

In addition, a surface light source device according to a seventh aspect is the surface light source device according to the fifth aspect, in which the plurality of light sources are disposed in a zig-zag manner such that a parallelogram is hypothesized as the quadrangle.

In the invention according to the seventh aspect, luminance uniformity can be improved with certainty, even in instances in which the point-like light sources are disposed in a zig-zag manner.

In addition, a surface light source device according to an eighth aspect is the surface light source device according to the sixth aspect, in which the pyramid is a quadrangular pyramid. All opening edges of the pyramid form an angle of 22.5° in relation to a predetermined edge of the four edges of the square and either of the two diagonal lines of the square in a state in which the bottom edges are projected on the plane.

In the invention according to the eighth aspect, offset angle of the bottom edges of the projection in relation to a predetermined edge and one diagonal line of the square can be distributed in a well-balanced manner. As a result, luminance uniformity can be further improved.

In addition, a surface light source device according to a ninth aspect is the surface light source device according to any one of the first to eighth aspect, in which the pyramid is a quadrangular pyramid, and an angle formed by two triangular surfaces that face each other of the pyramid is 90°.

In the invention according to the ninth aspect, the projections or the recesses in the second surface of the light diffusing member can be formed into a shape suitable for performing total reflection of light close to the light source. Therefore, luminance uniformity can be further improved.

Furthermore, a surface light source device according to a tenth aspect is the surface light source device according to any one of the first to ninth aspect, in which light beam control members that respectively control light distribution characteristics of the light from the light sources are respectively disposed in positions near the exit-direction side of the light sources. The number of light beam control members is the same as the number of light sources. Each light beam control member controls the light distribution characteristics of the light from the light source such that a maximum light intensity value is present in a direction having a predetermined angle in relation to an optical axis.

In the invention according to the tenth aspect, the light beam control member is used that actualizes light distribution characteristics such that peak light intensity is present in a direction offset from the optical axis direction. Therefore, luminance directly above the point-like light sources can be efficiently reduced. As a result, further luminance uniformity and reduced thickness of the surface light source device can be achieved.

### Effect of the Invention

In the present invention, luminance uniformity can be improved with certainty by a simple configuration, and a surface light source having favorable visibility can be actualized.

### BRIEF DESCRIPTION OF DRAWINGS

FIG. 1 is a schematic perspective view of a surface light source device according to a first embodiment of the present invention.

FIG. 2 is a schematic diagram of placement of light emitting elements in the surface light source device according to the first embodiment of the present invention.

FIG. 3A is a planar view of a diffusing plate and FIG. 3B is a cross-sectional view taken along line A-A in FIG. 3A, in the surface light source device according to the first embodiment of the present invention.

FIG. 4 is a conceptual diagram of light beam control performed by projections of the surface light source device according to the first embodiment of the present invention.

FIG. 5 is a conceptual diagram of an angular relationship between edge sections of the projections and edge sections and diagonal lines of a square hypothesized for a set of four light emitting elements in the surface light source device according to the first embodiment of the present invention.

FIG. 6 is a schematic diagram of a more preferable embodiment of the surface light source device according to the first embodiment of the present invention.

FIG. 7A is a planar view of a variation example of the diffusing plate and FIG. 7B is a cross-sectional view taken along line A-A in FIG. 7A, in the surface light source device according to the first embodiment of the present invention.

FIG. 8 is an explanatory diagram for explaining the conditions of illuminance measurement simulation in an example according to the first embodiment.

FIG. 9 is diagrams of an overview of a sample of Example 1 and simulation results in the example according to the first embodiment.

FIG. 10 is a diagram of simulation results of a sample of Comparison Example 1 in the example according to the first embodiment.

FIG. 11 is diagrams of an overview of a sample of Comparison Example 2 and simulation results in the example according to the first embodiment.

FIG. 12 is diagrams of an overview of a sample of Comparison Example 3 and simulation results in the example according to the first embodiment.

FIG. 13 is a schematic diagram of placement of light emitting elements in the surface light source device according to a second embodiment of the present invention.

FIG. 14 is a conceptual diagram of an angular relationship between edge sections of projections and edge sections and diagonal lines of a parallelogram hypothesized for a set of four light emitting elements in the surface light source device according to the second embodiment of the present invention.

FIG. 15 is an explanatory diagram for explaining the conditions of illuminance measurement simulation in an example according to the second embodiment.

FIG. 16 is diagrams of an overview of a sample of Example 2 and simulation results in the example according to the second embodiment.

FIG. 17 is a diagram of simulation results of a sample of Comparison Example 4 in the example according to the second embodiment.

FIG. 18 is diagrams of an overview of a sample of Comparison Example 5 and simulation results in the example according to the second embodiment.

FIG. 19 is diagrams of an overview of a sample of Comparison Example 6 and simulation results in the example according to the second embodiment.

### BEST MODE(S) FOR CARRYING OUT THE INVENTION

### First Embodiment

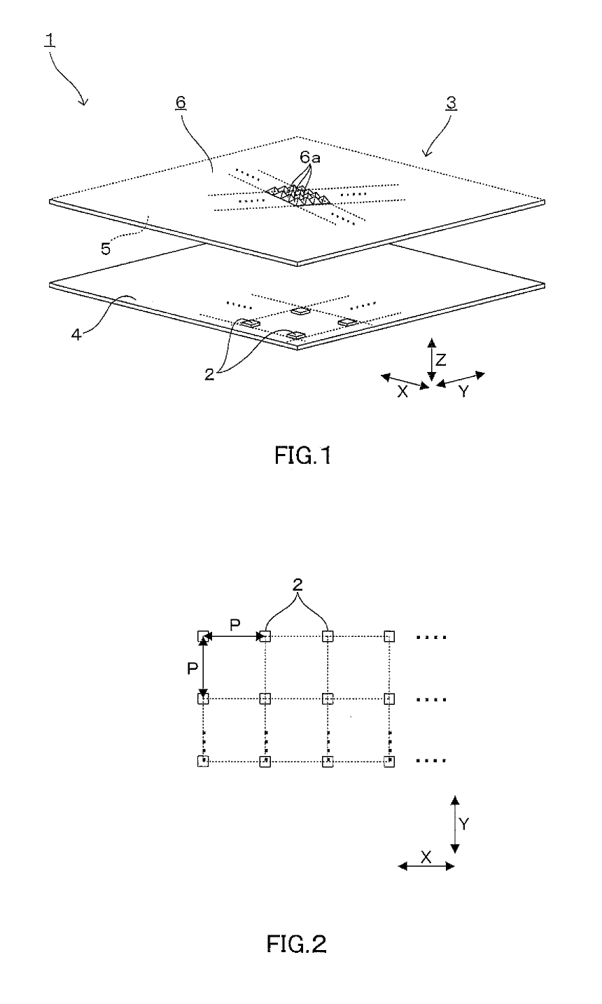

A surface light source device according to a first embodiment of the present invention will hereinafter be described with reference to FIG. 1 to FIG. 12.

As shown in FIG. 1, a surface light source device 1 according to the present embodiment has a plurality of light emitting elements 2 serving as a plurality of point-like light sources. Each light emitting element 2 may be a light-emitting diode (LED).

Specifically, as shown in FIG. 1, the light emitting elements 2 are disposed on a top surface of a mounting substrate 4 serving as a same plane, such as to be spaced apart two-dimensionally in an X-axis direction and a Y-axis direction in FIG. 1. The exit direction of light of each light emitting element 2 (optical axis direction that is the center of a three-dimensional light beam from the light emitting element 2) is the direction of a surface normal (Z-axis direction in FIG. 1) to the top surface of the mounting substrate 4. In other words, the exit direction of light from each light emitting element 2 is parallel with one another.

In addition, a quadrangle can be hypothesized between one arbitrary light emitting element 2 and three other predetermined light emitting elements 2 near the one light emitting element 2, among the plurality of light emitting elements 2. The light emission centers of the four predetermined light emitting elements 2 serve as the apexes of the quadrangle. The quadrangle does not include the light emission center of a light emitting element 2 other than the four light emitting elements 2 on the four edges and in the area surrounded by the four edges of the quadrangle.

More specifically, as shown in FIG. 2, the light emitting elements 2 are disposed in a square lattice shape at an even pitch P in the X-axis direction and the Y-axis direction. As indicated by broken lines in FIG. 2, a square having the same dimension (a quadrangle of which the outer perimeter length is the shortest) can be hypothesized as the quadrangle for each set of four light emitting elements 2, in the light emitting elements 2 disposed as described above. The apexes of each square are taken over the light emission centers (in other words, the exit point of the center light) of the four corresponding light emitting elements 2. As shown in FIG. 2, the light emission center of a light emitting element 2 other than the four light emitting elements 2 corresponding to the square is not present on the four edges and in the area surrounded by the four edges of each square.

Returning to FIG. 1, a light diffusing plate 3 is disposed in a position on the light-exiting direction (Z-axis direction) side in relation to the light emitting elements 2. The light diffusing plate 3 that, with the light emitting elements 2, serves as a light diffusing member configuring the surface light source device 1 is disposed such as to oppose the top surface (X-Y plane) of the mounting substrate 4. The light diffusing plate 3 can be formed, for example, by a resin material such as methacrylate resin, polystyrene resin, polycarbonate resin, cycloolefin resin, methacrylate-styrene copolymer resin, or cycloolefin-alkene copolymer resin, or a light-transmitting material such as glass. The light diffusing plate 3 may also be formed such as to be translucent by a dispersing agent of which the main ingredient is titanium oxide or calcium carbonate, or a scatterer such as silicone particles being added.

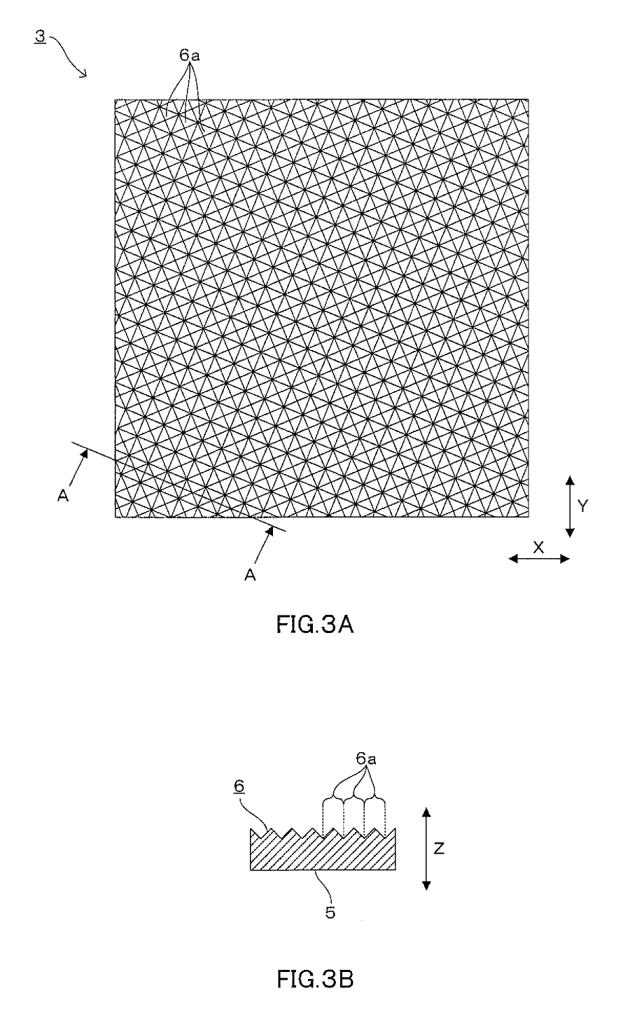

As shown in FIG. 1 and FIG. 3A, the light diffusing plate 3 spreads two-dimensionally in parallel with the X-Y plane and has a predetermined thickness in the Z-axis direction. The light diffusing plate 3 has a first surface 5 that is parallel with the X-Y plane and opposes the light emitting elements 2, and a second surface 6 on the side opposite to the first surface 5 in the Z-axis direction. After the light emitted from each light emitting element 2 enters the light diffusing plate 3 from the flat (smooth) first surface 5, the light exits from the second surface 6 in a state in which the light path has been converted. Here, the second surface 6 contributes to light path conversion of light in the light diffusing plate 3. As shown in FIG. 1 and FIG. 3B, a plurality of prism-like projections 6a having a square pyramid shape projecting towards the side opposite to the first face 5 are formed on the second surface 6. The prism-like projections 6a are arrayed two-dimensionally along edges (bottom edges) forming a square plane that is a virtual bottom surface of the square pyramid. The prism-like projections 6a are disposed in a continuous array. Therefore, one arbitrary prism-like projection 6a shares one edge among the four bottom edges with another prism-like projection 6a adjacent thereto. In addition, two edges among the four bottom edges (the two edges perpendicular to the one edge shared between the adjacent prism-like projections 6a) each form a pair of bottom edges forming a straight line with an edge of the adjacent prism-like projection 6a. As a result, in a planar view of the overall prism-like projections 6a, the bottom edges of the prism-like projections 6a form a square-lattice mesh shape. However, because each prism-like projection 6a is formed having a small dimension of, for example, several tens of micrometers to several hundreds of micrometers, the specific shapes of the prism-like projections 6a are not required to be visible.

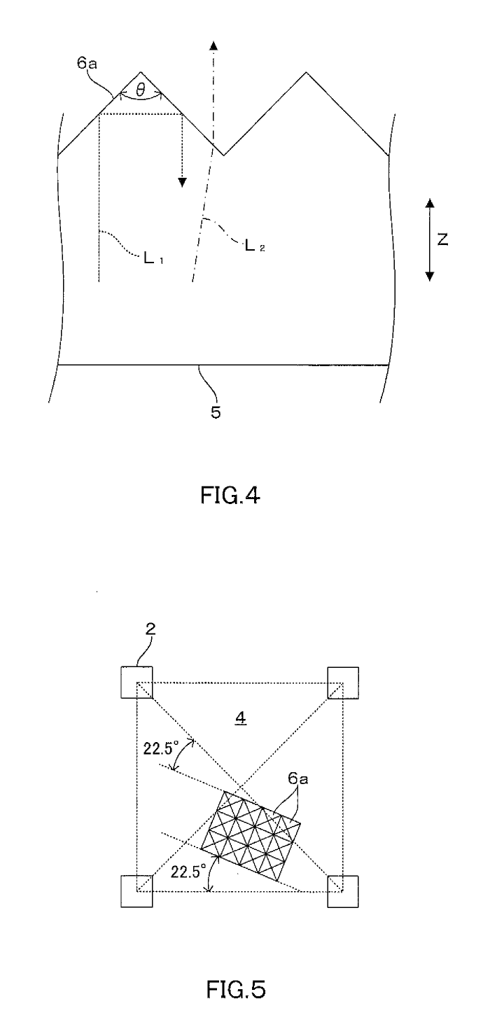

Here, as shown in FIG. 4, the prism-like projection 6a returns light L₁ near the optical axis of each light emitting element 2 among the light (light beam) internally incident on the prism-like projection 6a from the first surface 5 side (in other words, the light ray internally incident on the prism-like projection 6a at an angle of incidence larger than the critical angle) towards the first surface 5 side using total reflection that is performed twice. The light L₁ that has returned to the first surface 5 side in this way exits the first surface 5 towards the mounting substrate 4 side and is then reflected/diffused by the surface of the mounting substrate 4 and a reflection/diffusion surface or the like of a housing (not shown) disposed further behind (below) the mounting substrate 4. In some instances, the light L₁ subsequently enters the first surface 5 again and is used as a surface light source. On the other hand, as shown in FIG. 4, the prism-like projection 6a refracts light L₂ having a large angle in relation to the optical axis of each light emitting element 2 among the light (light beam) internally incident on the prism-like projection 6a from the first surface 5 side (in other words, the light ray internally incident on the prism-like projection 6a at an angle of incidence smaller than the critical angle) towards the outer side (above) the second surface 6 and allows the light L₂ to pass through. The light L₂ is then used as a surface light source. In this way, the prism-like projections 6a are configured to adjust the positional balance of light quantity of the light exiting the second surface 6. Specifically, the prism-like projections 6a achieve overall luminance uniformity by securing light quantity in positions away from the regions directly above the light emitting elements 2, while suppressing light quantity directly above the light emitting elements 2.

However, an issue in that sections where light intensity becomes strong and sections where light intensity becomes weak are positionally unevenly distributed in the outgoing light (planar light) from the light diffusing member remains as in the past when the above-described configuration is used alone. The above-described configuration is still insufficient for achieving luminance uniformity.

Therefore, according to the first embodiment, a means for effectively responding to the above-described issue is achieved.

In other words, as shown in FIG. 5, according to the first embodiment, the four bottom edges of each projection 6a have a positional relationship that is twisted in relation to the four edges and diagonal lines of the square hypothesized for each set of four light emitting elements 2, described above. In other words, the four bottom edges of each projection 6a are disposed as skew lines in relation to the four edges and diagonal lines of the square hypothesized for each set of four light emitting elements 2. So, in a state in which the bottom edges of the projections 6a are projected onto a same plane as the light emitting elements 2, the bottom edges of the projections 6a are not parallel with any of the four edges or diagonal lines of the square hypothesized for the set of four light emitting elements 2.

According to a configuration such as this, the sections where light intensity (light quantity) becomes strong and the sections where light intensity (light quantity) becomes weak in the outgoing light from the second surface 6 of the light diffusing plate 3 can be positionally dispersed. Therefore, luminance uniformity can be improved. In addition, as a result, the thickness of the surface light source device 1 can be reduced by shortening the space between the light emitting elements 2 and the light diffusion plate 3, and cost can be lowered by reducing the number of light emitting elements 2, while maintaining favorable optical performance.

As shown in FIG. 5, the light diffusing plate 3 is preferably disposed such that the four bottom edges of each prism-like projection 6a form an angle of 22.5° in relation to a predetermined edge among the four edges of the square hypothesized with the positions of the four light emitting elements 2 serving as the apexes, and either of the two diagonal lines of the hypothesized square, in a state in which the four bottom edges of each prism-like projection 6a are projected onto the same plane as the square (the top surface of the mounting substrate 4). As a result of this configuration, the effect of brightening the region between two light emitting elements 2 by the prism-like projections 6a of the light diffusing plate 3 can be adjusted to an appropriate state, and luminance uniformity can be further improved.

More preferably, the apex angle of the prism-like projection, 6a is formed to be 90°. The apex angle refers to a narrow angle (e in FIG. 4) formed by two triangular surfaces that face each other among the four triangles of the conical surface of the prism-like projection 6a (the same applies hereafter). As a result of this configuration, the prism-like projection 6a can be formed into a shape suitable for performing total reflection (total reflection performed twice to return light to the first surface 5 side) of the light L₁ moving directly above the light emitting element 2. Therefore, luminance uniformity can be further improved.

### More Preferable Embodiment

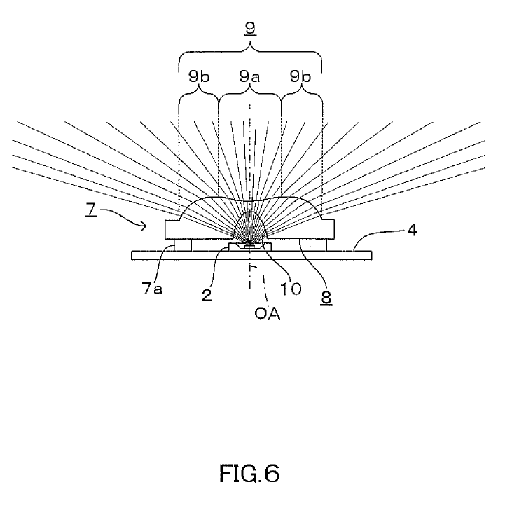

Furthermore, as a more preferable embodiment, as shown in FIG. 6, light beam control members 7 that respectively control the light distribution characteristics of the light from the light emitting elements 2 are disposed in positions near the exit-direction side of the light from the light emitting elements 2. The same number of light beam control members 7 as the light emitting elements 2 is disposed. The light beam control members 7 respectively control (convert) the light distribution characteristics of the light from the light emitting elements 2 such that the maximum light intensity value is present in a direction having a predetermined angle in relation to the optical axis OA.

Here, as shown in FIG. 6, the light beam control member 7 is formed having a rotatationally symmetrical shape with the optical axis OA as the symmetry axis. Each light beam control member 7 is disposed in a state in which the optical axis OA is positioned in alignment with the center axis (center light) of the light from the light emitting element 2. More specifically, the light beam control member 7 has a bottom surface 8 that opposes the top surface of the mounting substrate 4 and an exit surface 9 on the side opposite to the bottom surface 8 in the optical axis OA direction. A recess is formed in a position opposing the light emitting element 2 in a region of a predetermined range in the center (optical axis OA side) of the bottom surface 8. The recess serves as an entrance surface 10 having negative power of which the concave surface faces the light emitting element 2 side. On the other hand, a first region 9a of a predetermined range on the center side of the exit surface 9 is a negative power region of which the concave surface faces the side opposite to the light emitting element 2 (light diffusing plate 3 side). A second region 9b surrounding the first region 9a is a positive power region of which the convex surface faces the side opposite to the light emitting element 2. In addition, the second region 9b is formed such that the positive power (radius of curvature) gradually increases from the center side towards the peripheral side. The light beam control member 7 is positioned such as to come into contact with the top surface of the mounting substrate 4 with a leg section 7a therebetween.

The light that exits the light emitting element 2 with fixed directivity and spreading angle towards the light beam control member 7 first enters the interior of the light beam control member 7 from the entrance surface 10. At this time, as a result of refraction by the entrance surface 10 (although the center light travels straight forward), light beam control is performed such that the light beam (particularly the light rays near the optical axis OA) is dispersed.

Next, the light from the light emitting element 2 that has entered the interior of the light beam control member 7 in this way advances within the light beam control member 7 and reaches the exit surface 9 (internal incidence). Light beam control is then performed on the light that has reached the exit surface 9 by refraction by the exit surface 9 such that the light rays near the optical axis OA are further dispersed, and the light exits towards the light diffusing plate 3. However, the exit direction at this time is dependent on the respective powers of the first region 9a and the second region 9b. Control is performed such that the light beam moving in the direction having a predetermined angle in relation to the optical axis OA is relatively dense.

In this way, as a result of the light beam control member 7, light distribution characteristics in which the maximum light intensity value is present in the direction having a predetermined angle in relation to the optical axis OA are actualized. The maximum light intensity value may be present in a direction having an angle near 75° in relation to the optical axis OA.

As a result of this configuration, luminance directly above the light emitting element 2 can be efficiently reduced. Therefore, further luminance uniformity can be achieved.

In addition, because a large quantity of light can be sent in a direction having a large angle in relation to the optical axis OA, even when the distance between the light emitting elements 2 and the light diffusing plate 3 in the optical axis OA direction is shortened, light rays moving toward positions between light emitting elements 2 where light quantity tends to become insufficient can be obtained. Dark sections can be prevented from being formed. As a result, the surface light source device 1 can be further reduced in thickness while maintaining optical performance.

As technology similar to the light beam control member 7 such as that described above, various proposals have already been made by the applicant of the present application (refer to, for example, Japanese Patent Laid-open Publication No. 2009-211990).

### Variation Example

A specific configuration of the light diffusing plate 3 has been described above. However, the present invention is not limited to the above-described configuration. For example, a following variation example may be applied.

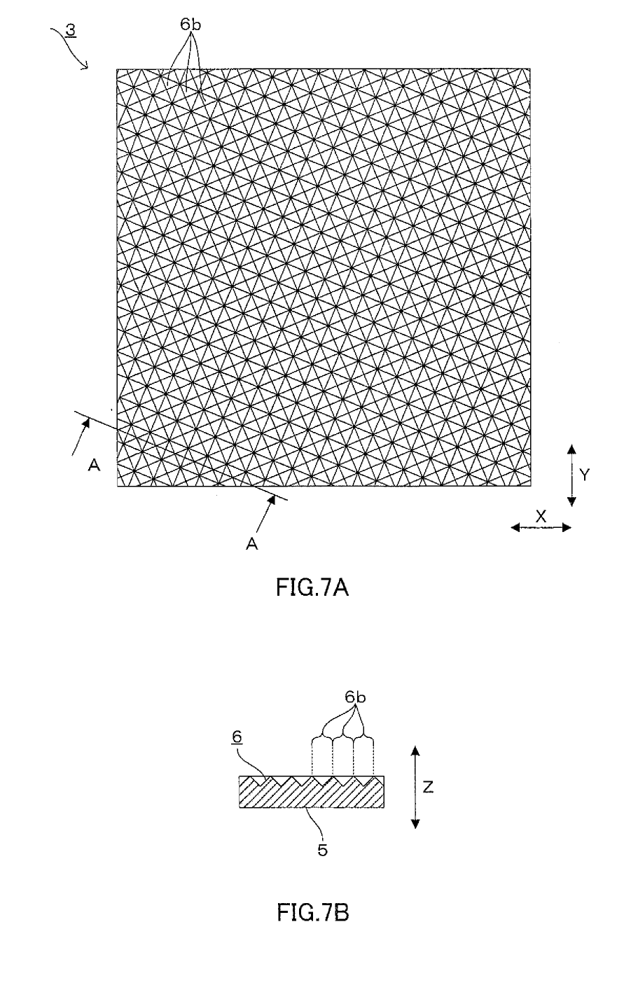

In other words, FIG. 7A and FIG. 7B show a variation example of the light diffusing plate 3. In the light diffusing plate 3 of the variation example, a surface section configuring the second surface 6 are prism-like recesses 6b. As shown in FIG. 7B, the prism-like recess 6b is a recessing surface having a square pyramid shape that recesses towards the first surface 5 side. The placement-position relationship between the prism-like recesses 6b, and the positional relationship (twist) between the bottom edges of the prism-like recess 6b (in other words, the edges configuring the opening rim) and the square (the four edges and the diagonal lines) hypothesized with the positions of the four light emitting elements 2 serving as the apexes are similar to those of the prism-like projections 6a. Therefore, detailed descriptions thereof are omitted.

Operational effects similar to those of the light diffusing plate 3 having the prism-like projections 6a, described above, can also be achieved in instances in which the light diffusing plate 3 of the variation example is used.

In addition, various variation examples of the surface section of the second surface 6 are expected, such as a projecting surface having a equilateral-triangle pyramid shape projecting towards the side opposite to the first surface 5, a recessing surface having an equilateral-triangle pyramid shape recessing towards the first surface 5 side, or a projecting/recessing surface having a rectangular spindle shape.

Furthermore, in instances in which the present embodiment is applied to a backlight of a liquid crystal display device, for example, a light control member, such as a diffusing plate, a diffusing sheet, a prism sheet, or a luminance increasing film, may be disposed as required on the light diffusing plate 3, and a transparent liquid crystal display panel may be disposed over the light control member.

### Example 1

Next, a specific example according to the present embodiment will be described.

In the present example, a total of four surface light source device samples, Example 1 and Comparison Examples 1 to 3, were prepared. Illuminance measurement simulation was conducted on each of the four samples.

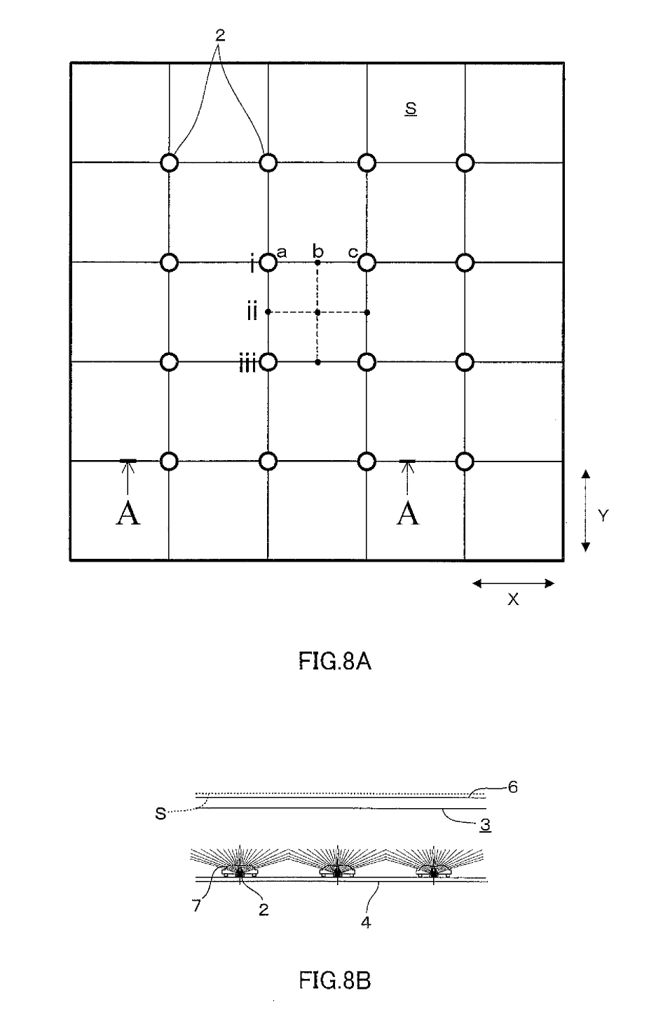

Here, as shown in FIG. 8A, in all samples, the light emitting elements 2 (four across and four down) configured by LEDs are disposed in a square lattice shape at a pitch of 50 mm in the X-axis direction and the Y-axis direction. In addition, as shown in FIG. 8B, in all samples, the light beam control member 7 is disposed above each light emitting element 2. The light beam control member 7 converts the light distribution characteristics of the light (LED light) emitted from the light emitting element 2 in a Lambertian distribution such that the peak value of light intensity is present in a direction having a predetermined angle (such as 75°) in relation to the optical axis OA (light beam control). In each sample excluding that of Comparison Example 1 that does not have the light diffusing plate 3, the light diffusing plate 3 is disposed in a position 10 mm from the top surface of the mounting substrate 4, and the surface section of the second surface 6 is the prism-like projections 6a having a square pyramid shape of which each bottom edge is 100 μm and the apex angle is 90°. Furthermore, as shown in FIG. 8B, an illuminance measuring plane S is set in a position near the exit side of the second surface 6 of the light diffusing plate 3 in parallel with the top surface of the mounting substrate 4 (in other words, the X-Y plane). However, regarding the measuring plane of Comparison Example 1 that does not have the light diffusing plate 3, the distance from the top surface of the mounting substrate 4 is set such that the measuring plane is in the same position as the measuring plane S of the other samples. Furthermore, the light diffusing plate 3 is assumed to be transparent and that in which a diffusing agent has not been added.

Under such conditions, illuminance (relative value) simulation was conducted in which the value of illuminance directly above the light emitting element 2 is 100% on the measuring plane in a state in which the light diffusing plate 3 is not disposed (Comparison Example 1). The illuminance at representative measuring points on the measuring plane S, as shown in FIG. 8A, are compiled in table format. The representative measuring points corresponds with the four light emitting elements 2 in the center. More specifically, as shown in FIG. 8A, there is a total of nine representative measuring points: four measuring points (x, y)=(a, i) (c, i), (a, iii), and (c, iii) equivalent to the regions directly above the light emitting elements 2 (light emission centers), two measurement points (b, i) and (b, iii) equivalent to the regions between light emitting elements 2 in the X-axis direction (center points), two measurement points (a, ii) and (c, ii) equivalent to the regions between light emitting elements 2 in the Y-axis direction (center points), and one measurement point (b, ii) equivalent to the region between light emitting elements 2 in the diagonal line direction (center point).

Simulation results of each sample will hereinafter be successively described with an overview of each sample.

### Example 1

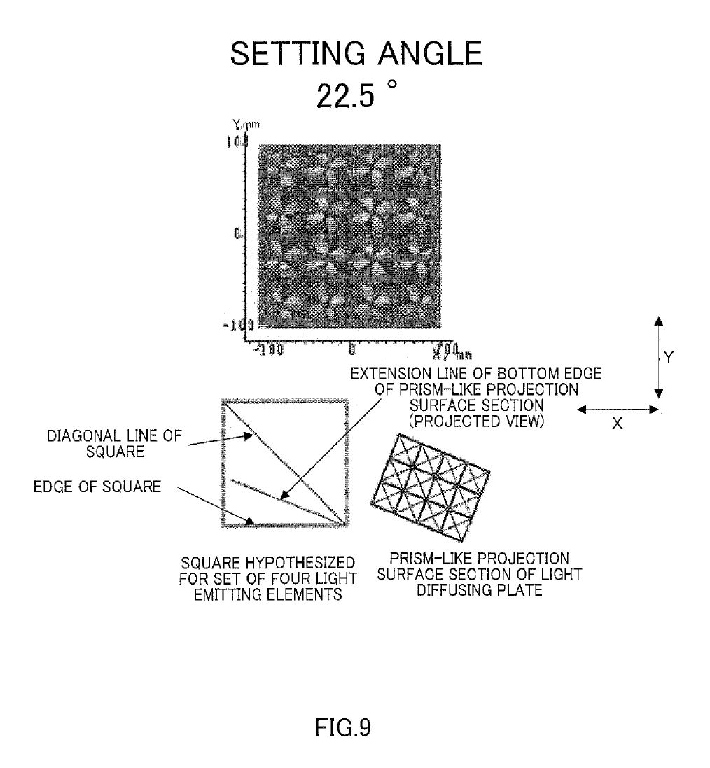

First, FIG. 9 shows the results of the simulation conducted on the sample of Example 1 with a schematic diagram of the sample.

As shown in FIG. 9, in the present sample, as the positional relationship that is twisted in relation to a predetermined edge and a predetermined diagonal line of the square hypothesized with the positions of the four light emitting elements 2 serving as the apexes, each bottom edge of the projection 6a has an angle of 22.5° (setting angle) on the same plane (projection plane). The present sample is equivalent to an aspect of the above-described surface light source device 1 according to the present embodiment.

As indicated by the simulation results in FIG. 9, in the present sample, a section where illuminance is relatively high was obtained as a bright section having a four-bladed windmill shape (90° pitch between blades) for each region of which the center is directly above the light emitting element 2. On the other hand, a section where illuminance is relatively low was obtained as a dark section. As shown in FIG. 9, in the present sample, a chain of blades is not formed between the windmill-shaped bright sections. As a whole, illuminance distribution is achieved in which the sections where illuminance (in other words, light intensity) is high and the sections where illuminance is low are present in a positionally dispersed manner.

The illuminance at the representative measuring points of the present sample are shown in Table 1.

TABLE 1

| | a | b | c |
|---|---|---|---|
| i | 100% | 102% | 100% |
| ii | 101% | 86% | 100% |
| iii | 100% | 103% | 100% |

As shown in Table 1, in the present sample, the differences in illuminance among the measuring points are 0% at minimum and 17% at maximum. In addition, the difference in illuminance between the measuring point directly above the light emitting element 2 (a, i) and the like and the measuring point between diagonally opposing light emitting elements 2 (b, ii) is 14%. The results are sufficiently favorable in terms of illuminance uniformity. Taking into consideration that a diffusing agent is added to the light diffusing plate 3 in practical use, extremely favorable luminance uniformity can be expected in which the light spreads evenly in the X-axis direction, the Y-axis direction, and the diagonal directions.

### Comparison Example 1

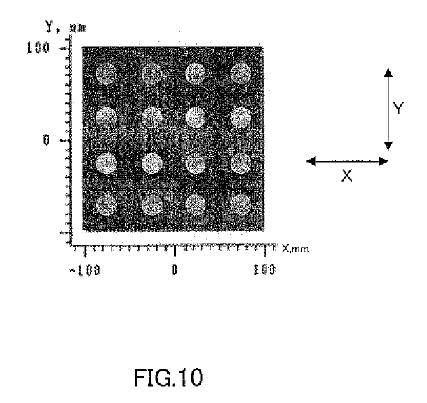

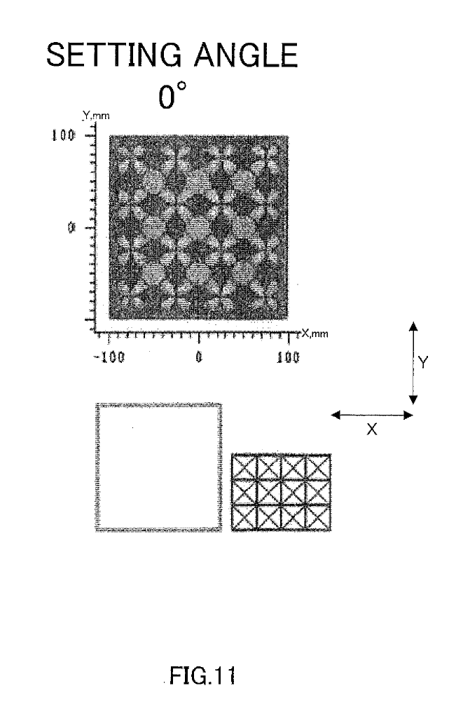

Next, FIG. 10 shows the results of the simulation conducted on the sample of Comparison. Example 1.

As described above, the present sample does not have the light diffusing plate 3. Therefore, a diagram of an overview of the configuration, such as that in FIG. 9, is omitted.

As shown in FIG. 10, in the present sample, a section where illuminance is relatively high was obtained as a circular bright section for each region of which the center is directly above the light emitting element 2. As a whole, illuminance distribution is achieved in which the sections where illuminance is high are localized directly above the light emitting elements 2.

The illuminance at the representative measuring points of the present sample are shown in Table 2.

TABLE 2

| | a | b | c |
|---|---|---|---|
| i | 100% | 6% | 100% |
| ii | 6% | 3% | 6% |
| iii | 100% | 6% | 100% |

As shown in Table 2, in the present sample, the differences in illuminance among the measuring points are 3% at minimum and 100% at maximum. The decrease in illuminance in the region between light emitting elements 2 (in the X-axis direction, Y-axis direction, and between diagonally opposing light emitting elements 2) from illuminance in the regions directly above the light emitting elements 2 is significant. The results are poor in terms of illuminance uniformity, and luminance uniformity cannot be expected.

### Comparison Example 2

Next, FIG. 11 shows the results of the simulation conducted on the sample of Comparison Example 2 with a schematic diagram of the sample.

As shown in FIG. 11, in the present sample, each bottom edge of the prism-like projection 6a is parallel with two predetermined edges of the square hypothesized with the positions of the four light emitting elements 2 serving as the apexes.

As indicated by the simulation results in FIG. 11, in the present sample, a section where illuminance is relatively high was obtained as a bright section having a four-bladed windmill shape (90° pitch between blades) for each region of which the center is directly above the light emitting element 2, in a manner similar to that in Example 1. However, unlike that in Example 1, in the present sample, chains of blades running in the diagonal line direction are formed between the windmill-shaped bright sections. As a whole, illuminance distribution is achieved in which the sections where illuminance is high are present such as to be concentrated in positions corresponding to the regions between the light emitting elements 2 in the diagonal line direction (between diagonally opposing light emitting elements 2).

The illuminance at the representative measuring points of the present sample are shown in Table 3.

TABLE 3

| | a | b | c |
|---|---|---|---|
| i | 99% | 81% | 99% |
| ii | 83% | 119% | 81% |
| iii | 101% | 83% | 101% |

As shown in Table 3, in the present sample, the difference in illuminance among the measuring points are 0% at minimum and 38% at maximum. In addition, the difference in illuminance between the measuring point directly above the light emitting element 2 (a, i) and the like and the measuring point between diagonally opposing diagonally opposing light emitting elements 2 (b, ii) is 20% at maximum. Illuminance between diagonally opposing light emitting elements 2 is noticeable. The results are insufficient in terms of illuminance uniformity compared to those of Example 1, and sufficient luminance uniformity is unlikely to be achieved.

### Comparison Example 3

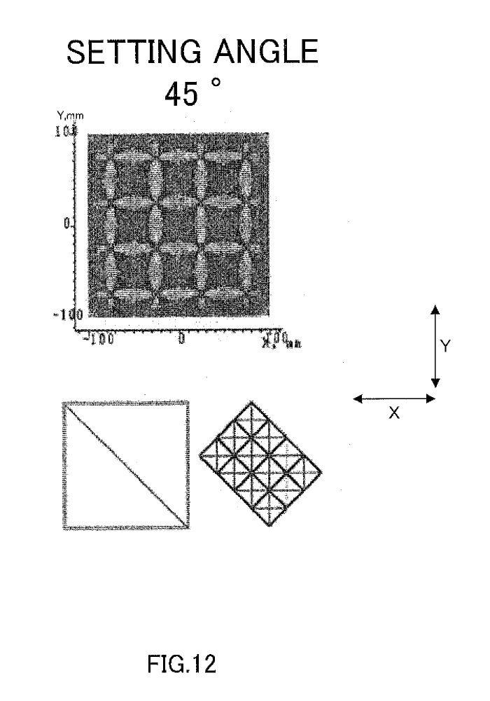

Next, FIG. 12 shows the results of the simulation conducted on the sample of Comparison Example 3 with a schematic diagram of the sample.

As shown in FIG. 12, in the present sample, each bottom edge of the projection 6a has an angle of 45° in relation to the four edges of the square hypothesized for the set of four light emitting elements 2, and is parallel with a predetermined diagonal line of the square.

As indicated by the simulation results in FIG. 12, in the present sample, a section where illuminance is relatively high was obtained as a bright section having a four-bladed windmill shape (90° pitch between blades) for each region of which the center is directly above the light emitting element 2, in a manner similar to that in Example 1. However, unlike that in Example 1, in the present sample, chains of blades running in the X-axis direction and the Y-axis direction are formed between the windmill-shaped bright sections. As a whole, illuminance distribution is achieved in which the sections where illuminance is high are present such as to be concentrated in positions corresponding to the regions between the light emitting elements 2 in the X-axis direction and the Y-axis direction and the sections where illuminance is low are present such as to be concentrated in positions corresponding to the regions between the light emitting elements 2 in the diagonal line direction.

The illuminance at the representative measuring points of the present sample are shown in Table 4.

TABLE 4

| | a | b | c |
|---|---|---|---|
| i | 100% | 131% | 100% |
| ii | 131% | 79% | 132% |
| iii | 100% | 133% | 100% |

As shown in Table 4, in the present sample, the differences in illuminance among the measuring points are 0% at minimum and 52% at maximum. In addition, the difference in illuminance between the measuring point directly above the light emitting element 2 (a, i) and the like and the measuring point between diagonally opposing light emitting elements 2 (b, ii) is 21%. The decrease in illuminance at the measuring point between diagonally opposing light emitting elements 2 is noticeable. The results are insufficient in terms of illuminance uniformity, and sufficient luminance uniformity is unlikely to be achieved.

### Second Embodiment

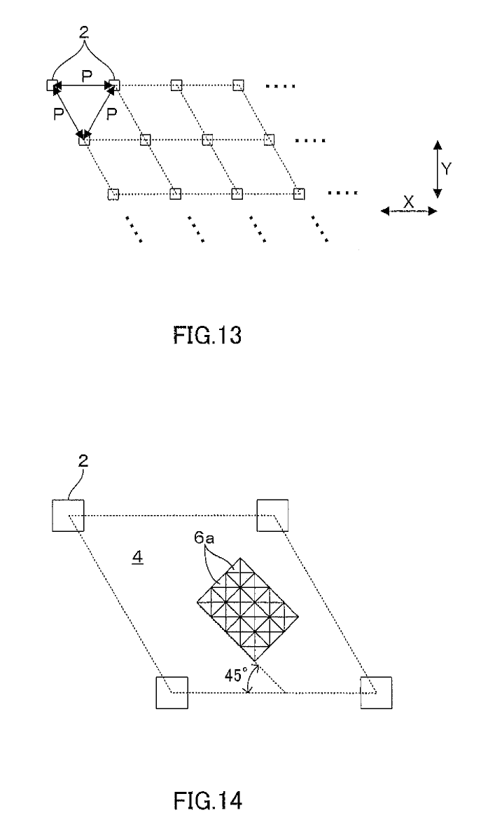

Next, a surface light source device according to a second embodiment of the present invention will hereinafter be described with reference to FIG. 13 to FIG. 19, focusing on the differences from the first embodiment. Basic configurations that are the same or similar to those according to the first embodiment are described using the same reference numbers.

As shown in FIG. 13, according to the present embodiment, the placement of the light emitting elements 2 differs from that according to the first embodiment. In other words, as indicated by broken lines in FIG. 13, the light emitting elements 2 are disposed in a zig-zag manner such that a parallelogram (a parallelogram of which the outer perimeter length is the shortest) can be hypothesized between one arbitrary light emitting element 2 and three other predetermined light emitting elements 2 near the one light emitting element 2. The light emission centers of the four light emitting elements 2 serve as the apexes of the parallelogram. The parallelogram does not include the light emission center of a light emitting element 2 other than the four light emitting elements 2 on the four edges and in the area surrounded by the four edges of the parallelogram. According to the present embodiment, the interior angle of the parallelogram hypothesized as described above is 60° or 120°. Two edges of the parallelogram, the upper and lower edges in FIG. 13, are parallel in the X-axis direction. Furthermore, as shown in FIG. 13, the light emitting elements 2 are disposed at an even pitch P in the direction of the four edges and the direction of the shorter diagonal line of the parallelogram.

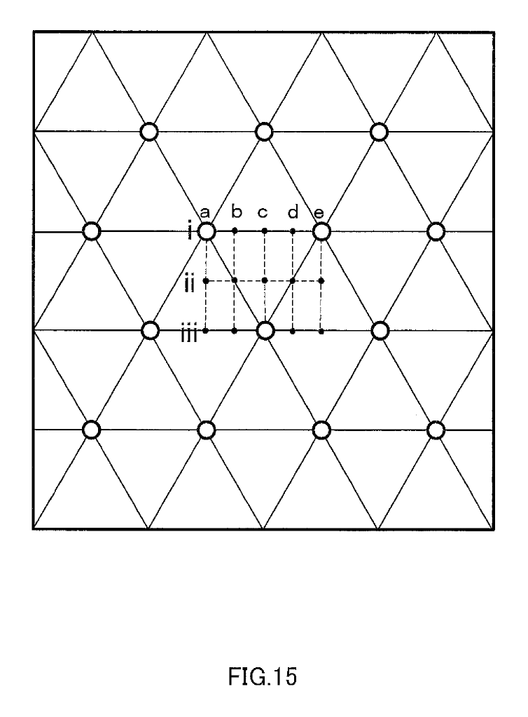

As shown in FIG. 14, according to the present embodiment, the four bottom edges of each prism-like projection 6a, described above, have a positional relationship that is twisted in relation to the four edges and diagonal lines of the parallelogram hypothesized for each set of four light emitting elements 2. In other words, in a state in which the bottom edges of the projections 6a are projected onto a same plane as the light emitting elements 2, the bottom edges of the projections 6a are not parallel with any of the four edges or diagonal lines of the parallelogram hypothesized for the set of four light emitting elements 2.

According to a configuration such as this, in a manner similar to that according to the first embodiment, the sections where light intensity becomes strong and the sections where light intensity becomes weak in the outgoing light from the second surface 6 of the light diffusing plate 3 can be positionally dispersed. Therefore, luminance uniformity can be improved.

As shown in FIG. 14, the four bottom edges of the prism-like projection 6a form an angle of 45° in relation to a predetermined edge among the four edges of the parallelogram hypothesized for the set of four light emitting elements, in a state in which the four bottom edges of the prism-like projection 6a are projected onto the same plane as the parallelogram (the top surface of the mounting substrate 4). As a result of this configuration, sufficient offset angle of the bottom edges of the prism-like projection 6a in relation to the predetermined edge of the parallelogram hypothesized for the set of four light emitting elements 2 can be ensured. In addition, the offset angles of the bottom edges of the prism-like projection 6a in relation to the edges other than the predetermined edge and the diagonal lines of the parallelogram can be distributed in a well-balanced manner (such as an even distribution by 15°). As a result, luminance uniformity can be further improved.

Other configurations are basically similar to those according to the first embodiment. In addition, various variation examples that can be applied according to the first embodiment can be applied accordingly in the present embodiment as well.

### Example 2

Next, a specific example according to the present embodiment will be described.

In the present example, a total of four surface light source device samples, Example 2 and Comparison Examples 4 to 6, were prepared. Illuminance measurement simulation was conducted on each of the four samples.

Here, as shown in FIG. 15, in all samples, the light emitting elements 2 (fourteen light emitting elements 2) configured by LEDs are disposed in a zig-zag manner with a pitch of 50 mm between adjacent light emitting elements 2. In a manner similar to the example according to the first embodiment, in all samples, the light beam control member 7 is disposed above each light emitting element 2 (see FIG. 8B).

As shown in FIG. 15, there are a total of 15 representative measuring points in the present example: three measuring points (x, y)=(a, i), (e, i), and (c, iii) equivalent to the regions directly above the light emitting elements 2, seven measuring points (b, i), (c, i), (d, i), (a, iii), (b, iii), (d, iii), and (e, iii) equivalent to the regions between light emitting elements 2 in the x-axis direction (quadrisection points), two measuring points (b, ii) and (d, ii) equivalent to the regions between light emitting elements 2 in the diagonal line direction (center point), and three measuring points (a, ii), (c, ii), and (e, ii) equivalent to the center points of vertical lines extending from the measuring points equivalent to the regions directly above the light emitting elements 2 to the edge sections of the parallelogram opposing the measuring points in the Y-axis direction.

Other simulation conditions are similar to those according to the first embodiment. Simulation results of each sample will hereinafter be successively described with an overview of each sample.

### Example 2

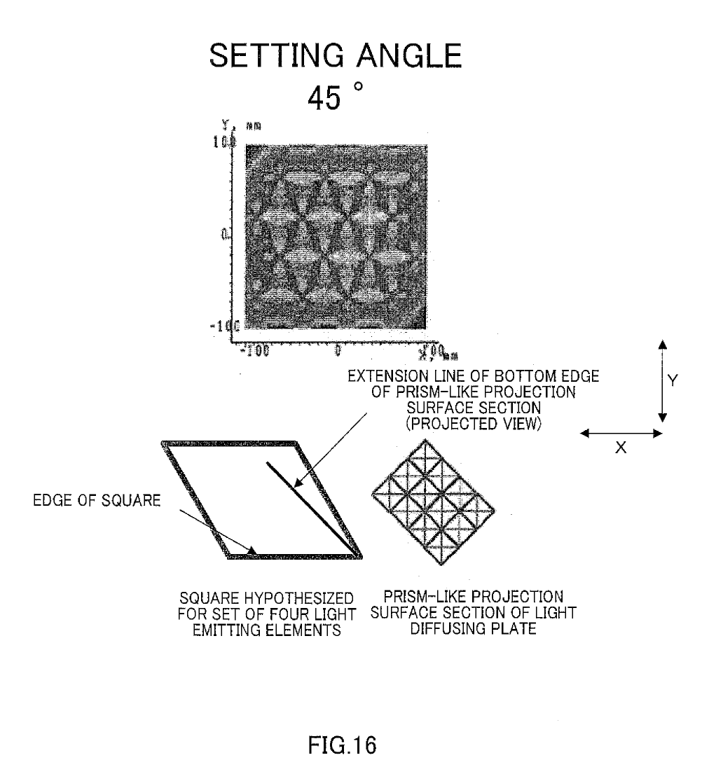

First, FIG. 16 shows the results of the simulation conducted on the sample of Example 2 with a schematic diagram of the sample.

As shown in FIG. 16, in the present sample, as the positional relationship that is twisted in relation to two edges of the parallelogram hypothesized for the set of the four light emitting elements 2, the bottom edges of the prism-like projection 6a has an angle of 45° on the same plane (projection plane). The present sample is equivalent to an aspect of the above-described surface light source device according to the present embodiment.

As indicated by the simulation results in FIG. 16, in the present sample, a section where illuminance is relatively high was obtained as a bright section having a four-bladed windmill shape (90° pitch between blades) for each region of which the center is directly above the light emitting element 2. As shown in FIG. 16, in the present sample, chains of blades are formed between the windmill-shaped bright sections. However, compared to the comparison examples described hereafter, illuminance distribution is achieved in which the sections where illuminance is high and the sections where illuminance is low are present in a positionally dispersed manner.

The illuminance at the representative measuring points of the present sample are shown in Table 5.

TABLE 5

| | a | b | c | d | e |
|---|---|---|---|---|---|
| i | 100% | 127% | 127% | 124% | 100% |
| ii | 114% | 99% | 113% | 100% | 113% |
| iii | 126% | 126% | 100% | 128% | 127% |

As shown in Table 5, in the present sample, the differences in illuminance among the measuring points are 0% at minimum and 29% at maximum. In addition, the differences in illuminance between the measuring point directly above the light emitting element 2 (a, i) and the like and the measuring points between diagonally opposing light emitting elements 2 (b, ii) and (d, ii) are 1% at maximum. The results are sufficiently favorable in terms of illuminance uniformity. Taking into consideration that a diffusing agent is added to the light diffusing plate 3 in practical use, favorable luminance uniformity can be expected.

### Comparison Example 4

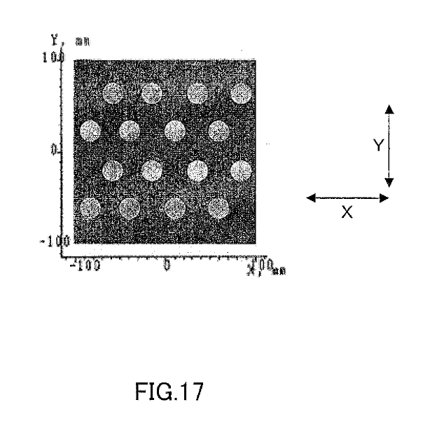

Next, FIG. 17 shows the results of the simulation conducted on the sample of Comparison Example 4.

In a manner similar to the sample of Comparison Example 1 according to the first embodiment, this sample does not have the light diffusing plate 3. Therefore, a diagram of an overview of the configuration, such as that in FIG. 16, is omitted.

As shown in FIG. 17, in the present sample, a section where illuminance is relatively high was obtained as a circular bright section for each region of which the center is directly above the light emitting element 2. As a whole, illuminance distribution is achieved in which the sections where illuminance is high are localized directly above the light emitting elements 2.

The illuminance at the representative measuring points of the present sample are shown in Table 6.

TABLE 6

| | a | b | c | d | e |
|---|---|---|---|---|---|
| i | 100% | 24 | 7% | 29% | 101% |
| ii | 8% | 7% | 7% | 7% | 8% |
| iii | 7% | 24% | 100% | 20% | 7% |

As shown in Table 6, in the present sample, the differences in illuminance among the measuring points are 0% at minimum and 94% at maximum. The decrease in illuminance in the regions (center points) between light emitting elements 2 from illuminance in the regions directly above the light emitting elements 2 is significant. The results are poor in terms of illuminance uniformity, and luminance uniformity cannot be expected.

### Comparison Example 5

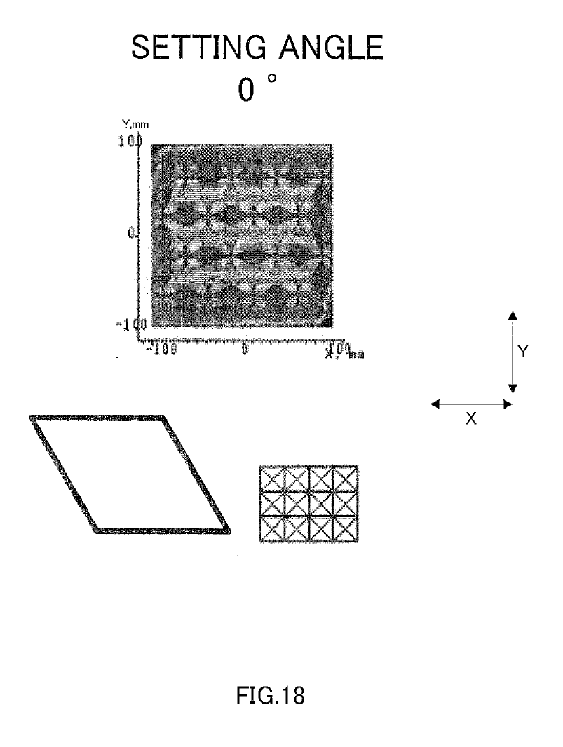

Next, FIG. 18 shows the results of the simulation conducted on the sample of Comparison Example 5 with a schematic diagram of the sample.

As shown in FIG. 18, in the present sample, the bottom edges of the prism-like projection 6a are parallel with two predetermined edges of the parallelogram hypothesized for the set of four light emitting elements 2.

As indicated by the simulation results in FIG. 18, in the present sample, a section where illuminance is relatively high was obtained as a bright section having a four-bladed windmill shape (90° pitch between blades) for each region of which the center is directly above the light emitting element 2, in a manner similar to that in Example 2. However, compared to that in Example 2, in the present sample, the state of the chain of blades between the windmill-shaped bright sections (the state of continuance) is stronger. The chain of blades is formed not only between adjacent windmills, but also extends to the windmill two windmills away and to the windmill adjacent to this as well. As a whole, illuminance distribution is achieved in which the sections where illuminance is high are present such as to be concentrated in the X-axis direction in positions equivalent to half the height (dimension in the y-axis direction) of the parallelogram.

The illuminance at the representative measuring points of the present sample are shown in Table 7.

TABLE 7

| | a | b | c | d | e |
|---|---|---|---|---|---|
| i | 101% | 99% | 89% | 100% | 99% |
| ii | 113% | 121% | 116% | 123% | 112% |
| iii | 90% | 98% | 100% | 96% | 89% |

As shown in Table 7, in the present sample, the differences in illuminance among the measuring points are 0% at minimum and 34% at maximum. Illuminance in the regions equivalent to the Y-coordinate ii including the region between diagonally opposing light emitting elements 2 is noticeable. The results are insufficient in terms of illuminance uniformity compared to those of Example 2, and sufficient luminance uniformity is unlikely to be achieved.

### Comparison Example 6

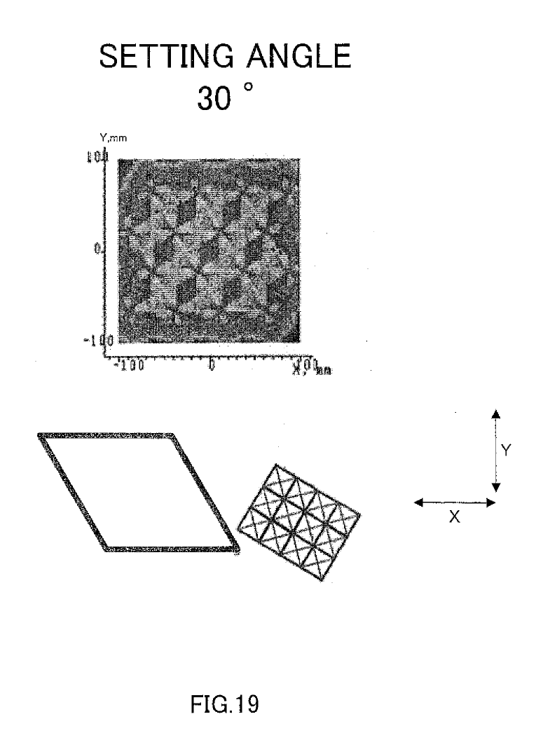

Next, FIG. 19 shows the results of the simulation conducted on the sample of Comparison Example 6 with a schematic diagram of the sample.

As shown in FIG. 19, in the present sample, the bottom edges of the prism-like projection 6a have an angle of 30° in relation to two predetermined edges of the parallelogram hypothesized for the set of four light emitting elements 2, and are parallel with one diagonal line of the parallelogram.

As indicated by the simulation results in FIG. 19, in the present sample, a section where illuminance is relatively high was obtained as a bright section having a four-bladed windmill shape (90° pitch between blades) for each region of which the center is directly above the light emitting element 2, in a manner similar to that in Example 2. However, compared to that in Example 2, the state of the chain of blades between the windmill-shaped bright sections is stronger. As a whole, illuminance distribution is achieved in which the sections where illuminance is high are present such as to be concentrated in the oblique line direction of the parallelogram.

The illuminance at the representative measuring points of the present sample are shown in Table 8.

TABLE 8

| | a | b | c | d | e |
|---|---|---|---|---|---|
| i | 100% | 129% | 126% | 134% | 99% |
| ii | 117% | 128% | 116% | 93% | 116% |
| iii | 127% | 129% | 100% | 134% | 127% |

As shown in Table 8, in the present sample, the differences in illuminance among the measuring points are 0% at minimum and 41% at maximum. The results are insufficient in terms of illuminance uniformity, and sufficient luminance uniformity is unlikely to be achieved.

The present invention is not limited to the above-described embodiments. Various modifications can be made without compromising the features of the present invention. For example, the present invention can be applied for uses other than in a liquid crystal display device (such as an internally illuminated signboard or a ceiling light).

1. A surface light source device, wherein:
a plurality of point-like light sources of which respective exit directions of light are parallel with one other are disposed on a same plane such as to be spaced apart two-dimensionally and are disposed such that, on four edges and within an area surrounded by the four edges of a quadrangle of which the apexes are light emission centers of four predetermined light sources, a light emission center point of a light source other than the four light sources is not included;
a light diffusing member having a first surface that opposes the light sources and a second surface on the side opposite of the first face, in which light emitted from each light source enters the first surface and exits the second surface in a dispersed state, is disposed in a position on the exit direction side in relation to the plurality of light sources such as to be parallel with the plane;
projections having a predetermined pyramid shape are formed in an array on the second surface of the light diffusing member; and
a virtual bottom surface of the projection positioned on the second surface is configured by a plurality of linear bottom edges, and all bottom edges are disposed as skew lines in relation to the four edges and the diagonal lines of the quadrangle.

2. The surface light source device according to claim 1, wherein the plurality of light sources are disposed in a square lattice shape such that a square is hypothesized as the quadrangle.

3. The surface light source device according to claim 1, wherein the plurality of light sources are disposed in a zig-zag manner such that a parallelogram is hypothesized as the quadrangle.

4. The surface light source device according to claim 2, wherein the pyramid is a quadrangular pyramid, and all bottom edges of the pyramid form an angle of 22.5° in relation to a predetermined edge of the four edges of the square and either of the two diagonal lines of the square in a state in which the bottom edges are projected on the plane.

5. A surface light source device, wherein:
a plurality of point-like light sources of which respective exit directions of light are parallel with one other are disposed on a same plane such as to be spaced apart two-dimensionally and are disposed such that, on four edges and within an area surrounded by the four edges of a quadrangle of which the apexes are light emission centers of four predetermined light sources, a light emission center point of a light source other than the four light sources is not included;
a light diffusing member having a first surface that opposes the light sources and a second surface on the side opposite of the first face, in which light emitted from each light source enters the first surface and exits the second surface in a dispersed state, is disposed in a position on the exit direction side in relation to the plurality of light sources such as to be parallel with the plane;
recesses having a predetermined pyramid shape are formed in an array on the second surface of the light diffusing member; and
an opening rim of the recess is configured by a plurality of linear opening edges, and all opening edges are disposed as skew lines in relation to the four edges and the diagonal lines of the quadrangle.

6. The surface light source device according to claim 5, wherein the plurality of light sources are disposed in a square lattice shape such that a square is hypothesized as the quadrangle.

7. The surface light source device according to claim 5, wherein the plurality of light sources are disposed in a zig-zag manner such that a parallelogram is hypothesized as the quadrangle.

8. The surface light source device according to claim 6, wherein the pyramid is a quadrangular pyramid, and all opening edges of the pyramid form an angle of 22.5° in relation to a predetermined edge of the four edges of the square and either of the two diagonal lines of the square in a state in which the bottom edges are projected on the plane.

9. The surface light source device according to any one of claims 1 to 8, wherein the pyramid is a quadrangular pyramid, and an angle formed by two triangular surfaces that face each other of the pyramid is 90°.

10. The surface light source device according to any one of claims 1 to 8, wherein:
light beam control members that respectively control light distribution characteristics of the light from the light sources are respectively disposed in positions near the exit-direction side of the light sources, the number of light beam control members being the same as the number of light sources; and
each light beam control member controls the light distribution characteristics of the light from the light source such that a maximum light intensity value is present in a direction having a predetermined angle in relation to an optical axis.

11. The surface light source device according to claim 9, wherein:
light beam control members that respectively control light distribution characteristics of the light from the light sources are respectively disposed in positions near the exit-direction side of the light sources, the number of light beam control members being the same as the number of light sources; and
each light beam control member controls the light distribution characteristics of the light from the light source such that a maximum light intensity value is present in a direction having a predetermined angle in relation to an optical axis.
